(19) United States
(12) Patent Application Publication
(10) Pub. No.: US 2015/0292663 A1
(43) Pub. Date: Oct. 15, 2015

(54) AN ASSEMBLY OF A FLEXIBLE PIPE AND AN END-FITTING

(71) Applicant: NATIONAL OILWELL VARCO DENMARK I/S, Brondby (DK)

(72) Inventors: Kristian Glejbol, Glostrup (DK); Jesper Ries, Soborg (DK)

(21) Appl. No.: 14/443,414

(22) PCT Filed: Nov. 18, 2013
(86) PCT No.: PCT/DK2013/050386

§ 371 Date: May 18, 2015

(30) Foreign Application Priority Data
Nov. 20, 2012 (DK) PA 2012 70716

(51) Int. Cl. F16L 39/02; F16L 19/07; F16L 35/00; F16L 21/00

(52) U.S. Cl. CPC F16L 39/02; F16L 21/007; F16L 19/07; F16L 35/00

(57) ABSTRACT

An assembly of a flexible pipe and an end-fitting, wherein the flexible pipe of the unbonded type comprises a plurality of layers including an outermost armor layer. At least the outermost armor layer is terminated and secured by securing material in a housing cavity of the end-fitting. The end-fitting comprises an annular end-fitting body structure and an annular outer casing, wherein an upper wall section of the housing cavity is provided by the outer casing. The outer casing comprises a strain-bearing fiber armored polymer layer arranged such that a tensile load subjected to the secured outermost armor layer results in strain in the strain-bearing fiber armored polymer layer.

### TECHNICAL FIELD

The present invention relates to a an assembly of an unbonded flexible pipe and an end-fitting, where the flexible pipe comprises a plurality of layers and is suitable for offshore and subsea transportation of fluids like hydrocarbons, CO2, water and mixtures hereof. In particular the flexible pipe is a riser pipe of the unbonded type.

### BACKGROUND ART

Unbonded flexible pipes as well as end-fittings therefore and assemblies thereof are well known in the art and are for example described in “Recommended Practice for Flexible Pipe”, ANSI/API 17 B, fourth Edition, July 2008, and the standard “Specification for Unbonded Flexible Pipe”, ANSI/API 17J, Third edition, July 2008.

Such pipes usually comprise an inner liner also often called an inner sealing sheath or an inner sheath, which is the innermost sealing sheath and which forms a barrier against the outflow of the fluid which is conveyed in the bore of the pipe, and one or more armoring layers. Often the pipe further comprises an outer protection layer which provides mechanical protection of the armor layers. The outer protection layer may be a sealing layer sealing against ingress of sea water. In certain unbonded flexible pipes one or more intermediate sealing layers are arranged between armor layers.

The term “unbonded” means in this text that at least two of the layers including the armoring layers and polymer layers are not bonded to each other. In practice the known pipe normally comprises at least two armoring layers located outside the inner sealing sheath and optionally an armor structure located inside the inner sealing sheath, normally referred to as a carcass.

The armoring layers usually comprise or consist of one or more helically wound elongated armoring elements, where the individual armor layers are not bonded to each other directly or indirectly via other layers along the pipe. Thereby the pipe becomes bendable and sufficiently flexible to roll up for transportation.

The end-fitting is usually coupled to the unbonded flexible pipe to terminate at least an outermost armor layer. In most situations the end-fitting is coupled to the unbonded flexible pipe to terminate all of the layers of the unbonded flexible pipe. The end-fitting is normally relatively stiff since the coupling between the unbonded flexible pipe and the end-fitting must be strong.

U.S. Pat. No. 6,273,142 discloses an assembly of an end-fitting and an unbonded flexible pipe comprising a number of layers including at least one layer having a number of helically wound flat metallic tensile armor wires with end parts which, in the assembled condition, are embedded in an anchor consisting of a casting material such as epoxy which is injected into a cavity formed in the end-fitting. The flat wire end parts have at least one twist turning generally around the centerline of the wire. The cavity formed in the end-fitting is provided between steel parts comprising an upper wall section provided by an outer casing. A similar assembly is disclosed in U.S. Pat. No. 8,220,129 where the outer casing (here called an outer jacket) is secured, using bolts, to the waist of the end-fitting body to form a cavity for injecting casting material.

For many applications it is required to apply a stiffener immediately adjacent to the end-fitting because the stress acting on the unbonded flexible pipe in the section of the unbonded flexible pipe immediately adjacent to the connection between the end-fitting and the unbonded flexible pipe otherwise may result in damaging of the unbonded flexible pipe, in particular where the end-fitting is to be fitted to an offshore installation, such as a platform. GB 2 291 686 describes such a bend stiffener for connecting a pipe to an offshore installation. The bend stiffener comprises an elongate polyurethane body molded around a metal sleeve which is fitted, in use, onto the end-fitting of an assembly of an assembly of an unbonded flexible pipe and an end-fitting. A similar bend stiffener is described in U.S. Pat. No. 6,009,907 which further is provided with means for dissipating heat at the interface between the stiffener and the unbonded flexible pipe.

U.S. Pat. No. 5,526,846 discloses another stiffener comprising an elastic member made of elastomer which surrounds an elongate body to be stiffened, the elastic member being integrally attached to one end of a housing support. For providing a better attachment to the metallic end-fitting the stiffener comprises inside its elastic material a reinforcement extending over a portion of the length of the elastic member.

### DISCLOSURE OF INVENTION

The object of the invention is to provide an assembly of an unbonded flexible pipe and an end-fitting which is suited for being combined with a stiffener, which can preferably be an integrated part of the assembly.

This object has been achieved by the present invention as defined in the claims.

It has been found that the invention and embodiments thereof have a number of additional advantages which will be clear to the skilled person from the following description.

The assembly of a flexible pipe and an end-fitting of the invention has shown to provide a very cost effective solution which is relatively simple to assemble. Further it has been found that the assembly of the invention provides a solution where tension applied to the pipe in a simple way can be monitored.

The assembly of the invention comprises a flexible pipe comprises a plurality of layers including an outermost armor layer. The flexible pipe is advantageously an unbonded flexible pipe comprising a plurality of layers which are not bonded. The term ‘bonded’ means herein interfacially bonded i.e. bonded layers are fully bonded along their interface.

The unbonded flexible pipe is advantageously ad described in “Recommended Practice for Flexible Pipe”, ANSI/API 17 B, fourth Edition, July 2008, and the standard “Specification for Unbonded Flexible Pipe”, ANSI/API 17J, Third edition, July 2008. However, in practice the unbonded flexible pipe may be any kind of unbonded flexible pipe suitable for subsea transportation of fluids and gasses. Further examples are provided below.

The assembly of the invention comprises an end-fitting wherein at least the outermost armor layer of the flexible pipe is terminated and secured by securing material in a housing cavity of the end-fitting.

End-fittings for flexible pipes are well known and examples are described in “Recommended Practice for Flexible Pipe”, ANSI/API 17 B, fourth Edition, July 2008, and the standard “Specification for Unbonded Flexible Pipe”, ANSI/API 17J, Third edition, July 2008.

The end-fitting of the assembly of the invention comprises an annular end-fitting body structure and an annular outer casing, wherein an upper wall section of the housing cavity is provided by the outer casing. The outer casing comprises a strain-bearing fiber armored polymer layer arranged such that a tensile load subjected to the secured outermost armor layer results in strain in the strain-bearing fiber armored polymer layer.

By providing the outer casing partly or totally by a strain-bearing fiber armored polymer layer instead of steal as in prior art end-fittings, the total cost as well as the total weight of the end-fitting of the assembly can be reduced. Further it is simpler to produce the outer casing which is usually specifically designed for the specific end-fitting. According to the invention it has been found that an outer casing comprising a strain-bearing fiber armored polymer layer surprisingly is sufficiently strong to ensure a safe and durable coupling between the end-fitting and the outermost armor layer which is usually a tensile armor layer. The tensile armor layer provides an excessive pull in the end-fitting, and heretofore it has not been even considered to provide any load-bearing parts of an end-fitting of other material than steel. The present invention accordingly provides a new and alternative solution, which in addition has a plurality of benefits as described herein.

It is believed that the tensile load subjected to the secured outermost armor layer by the pull in the flexible pipe provides stress in the securing material which generates the strain in the strain-bearing fiber armored polymer layer. The tensile load in the outermost armor layer in the length direction of the pipe or in the length direction of the elongate armor element of the outermost armor layer provides pressure build-up in the securing material. The pressure build-up in the securing material results in a strain in the radial direction and along the strain-bearing fiber armored polymer layer. In other words, the shear stress in the securing material results in a strain force in substantially radial direction which actually tightens the annular outer casing around the housing cavity.

The term “radial direction” means in a direction radial to the annular end-fitting body structure or to the flexible pipe. The radial direction to the annular end-fitting body structure will usually be identical to the radial direction to flexible pipe.

Accordingly the strain in the strain-bearing fiber armored polymer layer comprises at least radial strain. Depending on the fibers and in particular the orientation of the fibers of the strain-bearing fiber armored polymer layer the strain in the strain-bearing fiber armored polymer layer can also comprise strain in other directions, such as lengthwise strain.

The magnitude and direction of the strain in the strain-bearing fiber armored polymer layer can be determined using a stain sensor, such as a gauge, e.g. a foil gauge, an optical sensor, e.g. a distributed strain sensor, e.g. an FBG based sensor or other type of strain sensors. Advantageously the strain sensor is a biaxial strain sensor capable of determining strain in the radial as well as longitudinal direction. In a preferred embodiment the radial strain is determined by subjecting the secured outermost armor layer to a tensile load of about 100 kN or more.

The term “sealing sheath” is herein used to designate a liquid impermeable layer, normally comprising or consisting of polymer. The term “inner sealing sheath” designates the innermost sealing sheath. The term “intermediate sealing sheath” means a sealing sheath which is not the inner sealing sheath and which comprises at least one additional layer on its outer side. The term “outer sealing sheath” means the outermost sealing sheath. The term “outer protection sheath” is the outermost sheath which can be an outer sealing sheath but it can also be a liquid permeable sheath, unless otherwise specified.

In the following description the term “elongate armor element” when used in singular should be interpreted to also include the plural meaning of the term unless it is specifically stated that it means a single elongate armor element.

It should be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other stated features.

All features of the inventions including ranges and preferred ranges can be combined in various ways within the scope of the invention, unless there are specific reasons not to combine such features.

The term “substantially” should herein be taken to mean that ordinary product variances and tolerances are comprised.

The terms “inside” and “outside” a layer of the pipe are used to designate the relative distance to the axis of the pipe, such that “inside a layer” means the area encircled by the layer i.e. with a shorter axial distance than the layer, and “outside a layer” means the area not encircled by the layer and not contained by the layer, i.e. with a shorter axial distance than the layer.

The term “inner side” of a layer is the side of the layer facing the axis of the pipe. The term “outer side” of a layer is the side of the layer facing away from the axis of the pipe.

The term “innermost layer” means the layer closest to the centre axis of the pipe seen in radial direction and the “outermost layer” means the layer farthest from the centre axis of the pipe seen in radial direction.

The winding angle of the elongate armor element is determined relative to the center axis of the element onto which the elongate armor element is wound.

The term “composite armor elements” is herein used to mean any elongate armor element, such as strips or bundles of strips, comprising reinforced polymer, preferably fiber reinforced polymer.

Advantageously the assembly of the invention comprises a strain sensor coupled to the fiber armored polymer layer of the outer casing for monitoring strain. It has been found that by monitoring the strain in the strain-bearing fiber armored polymer layer of the outer casing, the pulling force in the outermost armoring layer can be monitored in a very simple and reliable way.

As mentioned the outermost armoring layer usually is a tensile armor layer comprising or consisting of a plurality of helically wound armor elongate armor element. Often the flexible pipe comprises two cross-wound (wound in opposite direction) armor layers with winding direction relative to the center axis of the pipe of from about 10 degrees to about 60 degrees, preferably from about 30 degrees to about 55 degrees.

Where the flexible pipe comprises two or more tensile armor layers, these two or more tensile armor layers advantageously are terminated and secured by the securing material in the housing cavity of the end-fitting, and thereby intimately connected to the securing material such that pulling forces in said two or more tensile armor layers thereby results in strain in the strain-bearing fiber armored polymer layer.

By monitoring the strain in the strain-bearing fiber armored polymer layer of the outer casing, the tensile armor layer(s) can in a simple way be monitored for damage or wear. The monitoring of the strain in the strain-bearing fiber armored polymer layer of the outer casing is in a preferred embodiment configured to detect any wire break of the tensile armor layer(s). “Wire break” means herein a break of any of the elongate armor elements of the tensile armor layer(s).

Advantageously the assembly comprises an integrated stiffener body for stiffening the pipe in a stiffened pipe section adjacent to the end-fitting, wherein the stiffener comprises a stiffener body which is an integrated extension of the strain-bearing fiber armored polymer layer of the outer casing.

By providing the assembly with an integrated stiffener body a very simple way of stiffening the pipe immediately adjacent to the end-fitting body is provided. The assembly with an integrated stiffener body has shown to provide a very strong and durable solution. Any risk of cracks and damage between end-fitting and stiffener is highly reduced.

In an embodiment the upper wall section of the housing cavity is at least partly provided by the strain-bearing fiber armored polymer layer. Preferably the upper wall section of the housing cavity is fully provided by the strain-bearing fiber armored polymer layer.

The outer casing can comprise minor amounts of metal, mainly for fitting it to the end-fitting body. The outer casing can also comprise parts or layers of non-fiber armored polymer.

Preferably the outer casing consists essentially of polymer and fibers and optionally metallic mounting element(s) and comprises a fiber armored polymer layer.

Advantageously the outer casing is free of a complete metal layer between the housing cavity and the strain-bearing fiber armored polymer layer. Thereby a more accurate strain monitoring can be provided. In an embodiment the outer casing is free of a metal layer extending about 5 cm or more in the length direction of the assembly of the unbonded flexible pipe and the end-fitting. In an embodiment the outer casing is free of a metal layer extending about 3 cm or more in the length direction of the assembly of the unbonded flexible pipe and the end-fitting.

The housing cavity is provided as in the prior art end-fitting with the difference that the outer casing is as described herein according to the invention.

Examples of prior art end-fittings that can be modified to be applied in the assembly of the invention are as described in U.S. Pat. No. 6,273,142, U.S. Pat. No. 8,220,129, US 2012/0211975, US 2010/0011556, U.S. Pat. No. 6,360,781 U.S. Pat. No. 6,923,477 or in “Recommended Practice for Flexible Pipe”, ANSI/API 17 B, fourth Edition, July 2008.

In an embodiment the housing cavity is provided by the end-fitting body structure and the outer casing and optionally a layer of the pipe.

The length direction of the assembly as well as of the end-fitting, the integrated stiffener body, and the flexible pipe is determined when the assembly is unloaded and along the center line of the assembly of the invention. The center line of the assembly will normally be a straight axis unless the integrated stiffener body is bent in an unloaded condition. Any length is determined along the length direction unless otherwise specified.

In an embodiment the end-fitting has a length direction coincident with the length direction of the assembly, and comprises a remote end with a coupling flange. The remote end of the end-fitting is in the opposite end of the end-fitting than the integrated stiffener body. The coupling flange may be as described in any of the prior art end-fitting referred to above. The coupling flange is provided for coupling the flexible pipe to another unit e.g. a tank, a pipe or other. Preferably the remote end of the end-fitting including the coupling flange is of metal.

In an embodiment the end-fitting body structure of the end-fitting comprises two or more end-fitting body elements. Preferably at least one of the end-fitting body elements is of metal.

As mentioned above the flexible pipe advantageously comprises a plurality of layers such as an unbonded flexible pipe. Advantageously the unbonded flexible pipe comprises from inside and out, a carcass, an innermost sealing sheath, a pressure armor layer, a pair of cross wound tensile armor layers and an outer protection/sealing sheath. The armor layers are most often metallic armor layers, but they may be or comprise composite armor elements of fiber armored polymer. The unbonded flexible pipe can additionally comprise other layers such as tape layers (anti-wear tape layer(s), anti-bird cage layers, and etc) insulation layer(s) and intermediate sealing sheath(s).

In an embodiment the plurality of layers of the unbonded flexible pipe is terminated in the end-fitting. Methods of terminating the individual layers in an end-fitting are well known in the art.

The integrated stiffener body is advantageously a tubular stiffener body having a length axis coincident with the length axis of the pipe.

The integrated stiffener body may have any length. Advantageously and in order to provide a useful stiffening effect, the integrated stiffener body has a length determined from the annular end-fitting body structure and along the length of the pipe which is at least about ½ m, preferably at least about 1 m, such as from about 2 to about 20 m.

The concentration and/or type of fibers may be equal or it may vary in the integrated stiffener body. By varying the concentration and/or type of fibers along the length of the integrated stiffener body, the stiffening effect provided can accordingly be graduated along the length of the integrated stiffener body.

In an embodiment the concentration of fibers in % by volume varies along the length of the integrated stiffener body, preferably the concentration of fibers in % by volume decreases with the distance to the annular end-fitting body structure.

In an embodiment the type, types and/or structure of fibers in the integrated stiffener body varies along the length of the integrated stiffener body.

In an embodiment the lay-angle or mixture of lay angles of fibres of the body varies along the length of the integrated stiffener body.

In an embodiment the integrated stiffener body is a tubular stiffener body with a wall thickness, wherein the wall thickness varies along the length of the integrated stiffener body, preferably the wall thickness decreases with the distance to the annular end-fitting body structure. Varying the wall thickness is another or supplementary way of graduating the stiffening effect provided along the length of the integrated stiffener body.

In an embodiment the integrated stiffener body is a tubular stiffener body with a wall thickness, and the wall thickness is substantially identical along at least about 90 of the length of the integrated stiffener body, preferably the wall thickness is substantially identical along at least about 95 of the length of the integrated stiffener body.

In an embodiment the integrated stiffener body is a layered structure. Optionally the outer casing and the integrated stiffener body are a common layered structure. Where a layered structure is provided it is generally desired that the layers are fully bonded to avoid undesired delamination.

The fibers used in the strain-bearing fiber armored polymer layer can in principle be any kind of fibers with a reinforcing effect.

In an embodiment the fibers of the strain-bearing fiber armored polymer layer are selected from basalt fibers, polypropylene fibers, carbon fibers, glass fibers, aramid fibers, steel fibers, polyethylene fibers, mineral fibers and/or mixtures comprising at least one of the foregoing fibers.

The amount of fibers in the strain-bearing fiber armored polymer layer and/or in the integrated stiffener body can for example be at least about 0.5% by weight of fibers, such as from about 1% to about 80% by weight of fibers, such as from about 10% to about 50% by weight of fibers.

In an embodiment fibers of the strain-bearing fiber armored polymer layer of the outer casing are predominantly oriented with length directions in the length direction of the assembly of the unbonded flexible pipe and the end-fitting, preferably more than 60% of the fibers are oriented with length directions in the length direction of the assembly of the unbonded flexible pipe and the end-fitting.

A fiber is determined to be oriented in the length direction of the composite elongate armor strips when its general orientation angle to the longitudinal direction is about 25 degrees or less.

The term “substantially all” means herein that a minor amount such as up to about 2% or less of the fibers can be arranged in another direction.

The term “cut fibers” means herein fibers of non continuous length, e.g. in the form of chopped fibers or melt blown fibers. The cut fibers are usually relatively short fibers e.g. less than about 5 cm, such as from about 1 mm to about 3 cm in length. The cut fibers may have equal or different lengths.

Filaments are continuous single fiber (also called monofilaments).

The phrase “continuous” as used herein in connection with the fibers, filaments, strands or rovings means that the fibers, filaments, strands, yarns or rovings generally have a significant length but should not be understood to mean that the length is perpetual or infinite. Continuous fibers, such as continuous filaments, strands, yarns or rovings preferably have length of at least about 10 m, preferably at least about 100 m, more preferably at least about 1000 m.

The term “strand” is used to designate an untwisted bundle of filaments.

The term “yarn” is used to designate a twisted bundle of filaments and/or cut fibers. Yarn includes threads and ropes. The yarn may be a primary yarn made directly from filaments and/or cut fibers or a secondary yarn made from yarns and/or cords. Secondary yarns are also referred to as cords.

The term “roving” is used to designate an untwisted bundle of strands or yarns. A roving includes a strand of more than two filaments. A non-twisted bundle of more than two filaments is accordingly both a strand and a roving.

In an embodiment of the invention the major amount, preferably at least about 60% by weight, more preferably substantially all of the fibers, is in the form of continuous fibers, such as continuous filaments, continuous yarns, continuous rovings, textile or combinations thereof.

In an embodiment the fibers of the strain-bearing fiber armored polymer layer comprise cut fibers and/or continuous fibers.

The strain-bearing fiber armored polymer layer advantageously is or comprises a thermoset polymer, preferably selected from epoxy resins, vinyl-epoxy-ester resins, polyester resins, polyimide resins, bis-maleimide resins, cyanate ester resins, vinyl resins, benzoxazine resins, benzocyclobutene resins, or mixtures comprising at least one of the forgoing thermoset polymers.

In an embodiment the polymer of the strain-bearing fiber armored polymer layer is or comprises a thermoplastic polymer, such as polyolefin, polyamide, polyimide, polyamide-imide, polyester, polyurethane, polyacrylate or mixtures comprising at least one of the forgoing thermoplastic polymers.

In an embodiment the fibers of the integrated stiffener body comprise cut fibers and/or continuous fibers.

In an embodiment the fibers of the integrated stiffener body in at least a length section thereof are predominantly oriented with length directions in the length direction of the assembly of the unbonded flexible pipe and the end-fitting.

In an embodiment the fibers of the strain-bearing fiber armored polymer layer of the outer casing are predominantly oriented with length directions in the length direction of the assembly and the fibers of the stiffener body are predominantly oriented with length directions perpendicular to the length direction of the assembly.

In an embodiment the major amount of the fibers of the integrated stiffener body is in the form of continuous fibers, preferably at least about 60% by weight of the fibers are in the form of textile or continuous fibers, such as continuous filaments, continuous yarns, continuous rovings or combinations thereof.

The fibers of the integrated stiffener body are advantageously as the fibers in the strain-bearing fiber armored polymer layer.

In an embodiment the fibers of the integrated stiffener body are selected from basalt fibers, polypropylene fibers, carbon fibers, glass fibers, aramid fibers, steel fibers, polyethylene fibers, mineral fibers and/or mixtures comprising at least one of the foregoing fibers.

In an embodiment the polymer of the integrated stiffener body is or comprises a thermoset polymer, preferably selected from epoxy resins, vinyl-epoxy-ester resins, polyester resins, polyimide resins, bis-maleimide resins, cyanate ester resins, vinyl resins, benzoxazine resins, benzocyclobutene resins, or mixtures comprising at least one of the forgoing thermoset polymers.

In an embodiment the polymer of the integrated stiffener body is or comprises a thermoplastic polymer, such as polyolefin, polyamide, polyimide, polyamide-imide, polyester, polyurethane, polyacrylate or mixtures comprising at least one of the forgoing thermoplastic polymers.

The integrated stiffener body advantageously comprises means for allowing water to cool the pipe covered with the integrated stiffener body when the assembly of the invention is submerged in water.

In an embodiment the integrated stiffener body has an inner side adapted to face towards the pipe, the inner side of the integrated stiffener body comprises channels, preferably oriented in length direction or in a helically configuration. The sea water can enter into the channel for cooling the pipe covered with the integrated stiffener body.

In an embodiment the integrated stiffener body comprises voids which are open to allow water to enter the voids when submerged under water.

In an embodiment the integrated stiffener body has a stiffener wall with an inner side adapted to face towards the pipe and an opposite outer side, the stiffener wall comprises voids provided by holes extending from the outer side to the inner side of the bend limiter wall.

In an embodiment the assembly comprises a bearing element arranged between the flexible pipe and the integrated stiffener body. The bearing element can advantageously be in the form of a wearing layer surrounding the flexible pipe.

The bearing element can be applied around the flexible pipe and advantageously be fixed to either the flexible pipe to the inner side of the integrated stiffener body or to both. Preferably the bearing element is fixed to the flexible pipe. The bearing element can be fixed using any suitable means such as by bonding, by adhesive or by clamping.

In an embodiment the bearing element is simply fixed to the integrated stiffener body at the end of the integrated stiffener body farthest from the end-fitting e.g. using one or more clamps.

Advantageously the bearing element is replaceable without dismounting the end-fitting from the flexible pipe. The bearing element can thereby provide a wearing layer which can be replaced when required.

In an embodiment the bearing element is applied to surround an outer surface of the flexible pipe, the bearing element has an outer surface facing the inner side of the integrated stiffener body, the outer surface of the bearing element has a lower friction than the outer surface of the flexible pipe.

Thereby any wear between the bearing element and the integrated stiffener body is reduced and the bearing element simultaneously protects the outer surface of the flexible pipe.

Advantageously the bearing element comprises cooling means for cooling the flexible pipe. The cooling means can be holes, orifices or other structural formations which allow water to cool the outer surface of the flexible pipe. In an embodiment the bearing element comprises channels, preferably oriented in length direction or in a helically configuration for cooling the outer surface of the flexible pipe. E.g. using the water into which the assembly is submerged. In an embodiment the bearing element comprises cooling channels adapted for actively cooling using circulated cooling fluid, such as water or air or any other suitable fluid.

In an embodiment the bearing element is a wound layer e.g. provided by one or more wound strips of suitable material, e.g. a polymer strip.

In an embodiment the bearing element is a folded layer e.g. of a polymer foil or mantle.

In an embodiment the bearing element is applied in the form of two or more panels.

In an embodiment the integrated stiffener body has a center line surrounded by a stiffener wall wherein the integrated stiffener body is fully rotational symmetrically around the centre line when the integrated stiffener body is unloaded.

In an embodiment the integrated stiffener body has a center line surrounded by a stiffener wall wherein the integrated stiffener body is at most two fold rotational symmetrical around the centre line when the integrated stiffener body is unloaded, preferably the integrated stiffener body is at most two fold rotational symmetrical around the centre line with respect to bending stiffness

The skilled person will understand that the above embodiments can be combined.

### BRIEF DESCRIPTION OF DRAWINGS

The invention will be explained more fully below in connection with a preferred embodiment and with reference to the drawings in which:

FIG. 1 is a schematic side view of an unbonded flexible pipe suitable for termination in an end-fitting to provide an end-fitting of the invention.

FIG. 2 is a schematic cross-sectional side view of an assembly of a flexible pipe and an end-fitting of the invention, wherein the outer casing is a strain-bearing fiber armored polymer layer.

FIG. 3 is a schematic cross-sectional side view of an assembly of a flexible pipe and an end-fitting of the invention, wherein the assembly comprises an integrated stiffener for stiffening the pipe.

FIG. 4 is a schematic cross-sectional side view of an assembly of a flexible pipe and an end-fitting of the invention, wherein the outer casing comprises a thin metal film and a strain-bearing fiber armored polymer layer.

FIG. 5 is a schematic cross-sectional side view of an assembly of a flexible pipe and an end-fitting of the invention, further comprising a bearing element arranged between the flexible pipe and the integrated stiffener body.

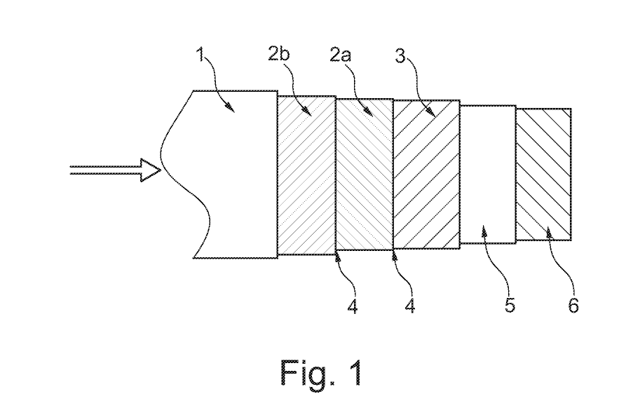

The flexible pipe e.g. a riser pipe shown in FIG. 1 is an example of a typically unbonded flexible pipe and comprises a liquid impervious inner sealing sheath 5 defining a bore as indicated with the bold arrow. The liquid impervious inner sealing sheath 5 can be of any polymer material suitable for forming such liquid impervious barrier. Examples of suitable polymer materials are high density polyethylene (HDPE), cross linked polyethylene (PEX), polyvinyldifluorid (PVDF) or polyamide (PA). The liquid impervious inner sealing sheath 5 has the purpose of preventing outflow of the fluid transferred in the bore of the pipe, indicated with the bold arrow. Inside the liquid impervious inner sealing sheath 5 the unbonded flexible pipe comprises an inner armor layer 6, called a carcass which is normally of metal, and has the main purpose of reinforcing the unbonded flexible pipe against collapse as described above. The carcass 6 is not liquid tight. On the outer side of the liquid impervious inner sealing sheath 5, the unbonded flexible pipe comprises a pressure armor layer 3 which is often of helically wound armor element(s) of metal or composite material, which is wound with a high angle to the center axis of the unbonded flexible pipe, such as an angle to the axis of the unbonded flexible pipe of about 70 degrees or more e.g. about 85 degrees. The pressure armor layer 3 is not liquid tight. In the metal armored unbonded flexible pipe it is generally desired that also the pressure armor is of metal.

Outside the pressure armor layer 3, the unbonded flexible pipe comprises two cross wound tensile armor layers 2a, 2b wound from elongate armor elements e.g. of composite material and/or metal. For example the elongate armoring elements on the innermost tensile armor layer 2a are wound with a winding degree of about 55 degrees or less to the axis of the unbonded flexible pipe in a first winding direction and the outermost tensile armor layer 2b is wound with a winding degree of about 60 degrees or less, such as between about 20 and about 55 degrees to the axis of the unbonded flexible pipe in a second winding direction which is the opposite direction to the first winding direction. The two armor layers with such opposite winding direction are normally referred to as being cross wound. The unbonded flexible pipe further comprises a liquid impervious outer sealing sheath 1 which protects the armor layers mechanically and against ingress of sea water. As indicated with the reference number 4, the unbonded flexible pipe preferably comprises anti-friction layers between the armor layers 3, 2a, 2b.

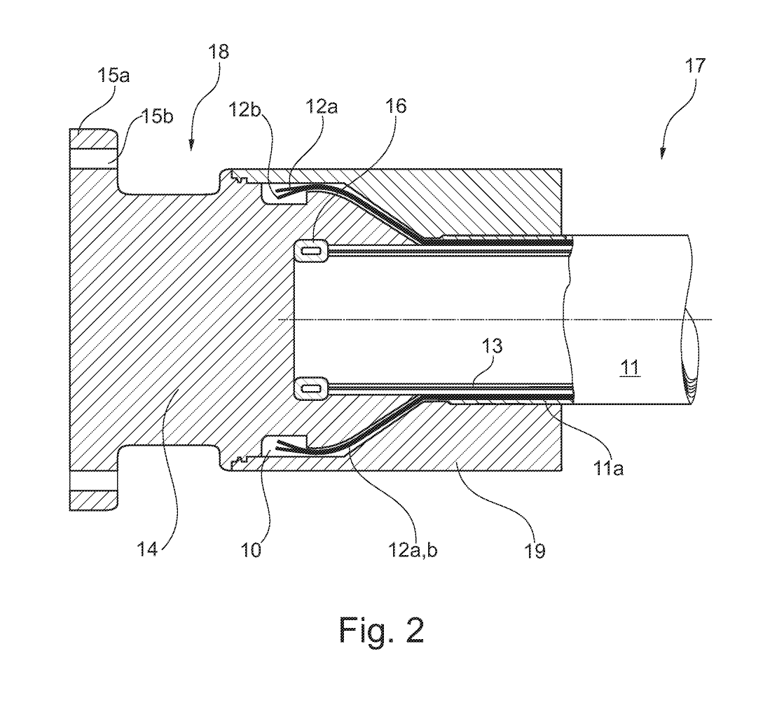

FIG. 2 shows an assembly of a flexible pipe 17 and an end-fitting 18 of the invention. The unbonded flexible pipe 18 comprises an outer sealing sheath 11, surrounding two cross wound tensile armor layers 12a, 12b. Inside the cross wound tensile armor layers 12a, 12b, the pipe comprises a number of other layers 13, including at least a liquid impervious inner sealing sheath and preferably additional layers as described above. The layers 13 inside the cross wound tensile armor layers 12a, 12b will usually be terminated individually, as shown schematically in the drawing with the terminating unit 16.

The end-fitting 18 comprises an end-fitting body 14 with a flange 15a with holes 15b for mounting to another part, e.g. another end-fitting or to a platform or a vessel. The end-fitting 18 further comprises an annular outer casing 19. A housing cavity 10 is formed between the end-fitting body 14 and the outer casing 19. The outer sealing sheath 11 is terminated at a termination point 11a in well known manner. The tensile armor elements of the tensile armor layers 12a, 12b are terminated and secured by securing material in the housing cavity 10 of said end-fitting 18. The outer casing 19 is in the form of a strain-bearing fiber armored polymer layer. When a pulling force is added to the tensile armor layers 12a, 12b in a direction away from the end-fitting 18, a strain will build up in the securing material in the housing cavity 10 of said end-fitting 18 resulting in a strain in said strain-bearing fiber armored polymer layer. As described above the strain in the strain-bearing fiber armored polymer layer can be detected by a strain gauge applied on the outer side of the outer casing 19.

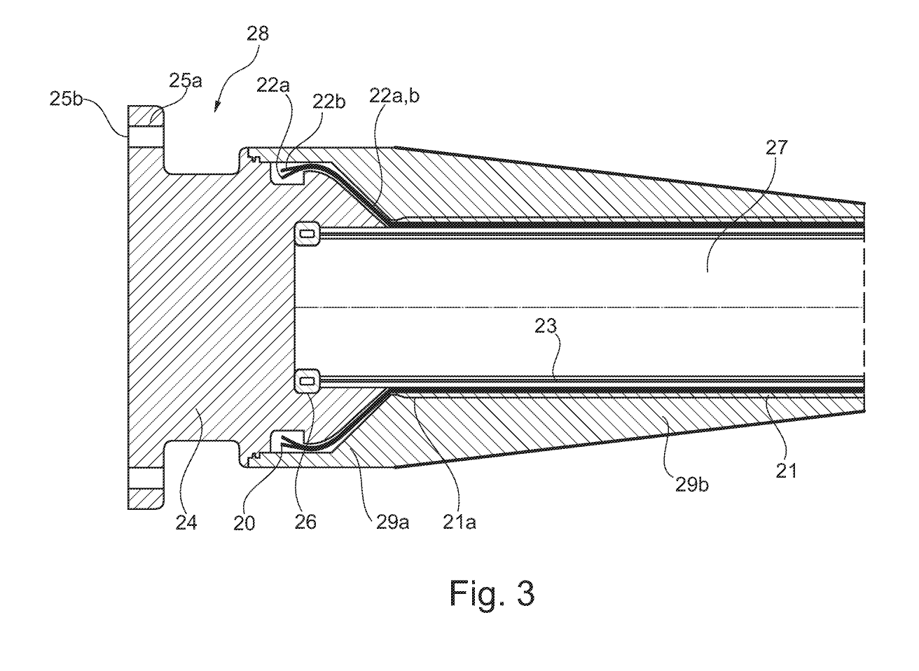

FIG. 3 shows an assembly of a flexible pipe 27 and an end-fitting 28 of the invention wherein the assembly comprises an integrated stiffener 29b for stiffening the pipe 27. The unbonded flexible pipe 28 comprises an outer sealing sheath 21 surrounding two cross wound tensile armor layers 22a, 22b. Inside the cross wound tensile armor layers 22a, 22b, the pipe comprises a number of other layers 23, including at least a liquid impervious inner sealing sheath and preferably additional layers as described above. The layers 23 inside the cross wound tensile armor layers 22a, 22b will usually be terminated individually, as schematically shown in the drawing with the terminating unit 26.

The end-fitting 28 comprises an end-fitting body 24 with a flange 25a with holes 25b for mounting to another part, e.g. another end-fitting or to a platform or a vessel. The end-fitting 28 further comprises an annular outer casing 29a. The annular outer casing 29a is integrated with the stiffener 29b in that the annular outer casing 29a and the stiffener 29b are in direct prolongation of each other—i.e. built together. A housing cavity 20 is formed between the end-fitting body 24 and the outer casing 29a. The outer sealing sheath 21 is terminated at a termination point 21a in well known manner. The tensile armor elements of the tensile armor layers 22a, 22b are terminated and secured by securing material in the housing cavity 20 of said end-fitting 28. The outer casing 29a is in the form of a strain-bearing fiber armored polymer layer which is extended to also provide the stiffener 29b of the same type of polymer optionally with fiber armoring. When a pulling force is added to the tensile armor layers 22a, 22b in a direction away from the end-fitting 28, a strain will build up in the securing material in the housing cavity 20 of said end-fitting 28 resulting in a strain in said strain-bearing fiber armored polymer layer.

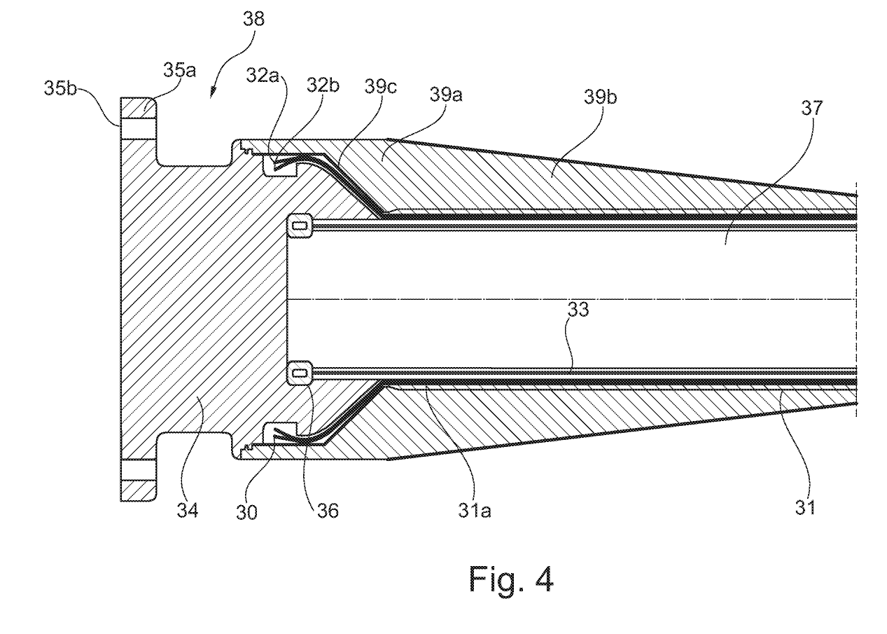

FIG. 4 shows an assembly of a flexible pipe 37 and an end-fitting 38 of the invention wherein the outer casing comprises a thin metal film 39c and a strain-bearing fiber armored polymer layer 39a. The assembly comprises an integrated stiffener 39b for stiffening the pipe 37. The unbonded flexible pipe 37 comprises an outer sealing sheath 31, surrounding two cross wound tensile armor layers 32a, 32b. Inside the cross wound tensile armor layers 32a, 32b, the pipe comprises a number of other layers 33, including at least a liquid impervious inner sealing sheath and preferably additional layers as described above. The layers 33 inside the cross wound tensile armor layers 32a, 32b will usually be terminated individually, as schematically shown in the drawing with the terminating unit 36.

The end-fitting 38 comprises an end-fitting body 34 with a flange 35a with holes 35b for mounting to another part. The end-fitting 38 further comprises an annular outer casing 39a, 39c. The annular outer casing 39a, 39c is integrated with the stiffener 39b in that the fiber armored polymer layer 39a of the annular outer casing and the stiffener 39b are in direct prolongation of each other—i.e. built together. A housing cavity 30 is formed between the end-fitting body 34 and the outer casing 39a. The outer sealing sheath 31 is terminated at a termination point 31a in well known manner. The tensile armor elements of the tensile armor layers 32a, 32b are terminated and secured by securing material in the housing cavity 30 of said end-fitting 38. The outer casing is in the form of the strain-bearing fiber armored polymer layer 39a and the thin metal film 39c. The metal film 39c may provide a simple sampling of the outer casing onto the end-fitting body 34, where the fiber armored polymer layer 39a can be protected against optionally heat generated by the securing material during hardening.

When a pulling force is added to the tensile armor layers 32a, 32b in a direction away from the end-fitting 38, a strain will build up in the securing material in the housing cavity 30 of said end-fitting 28 resulting in a strain in said strain-bearing fiber armored polymer layer.

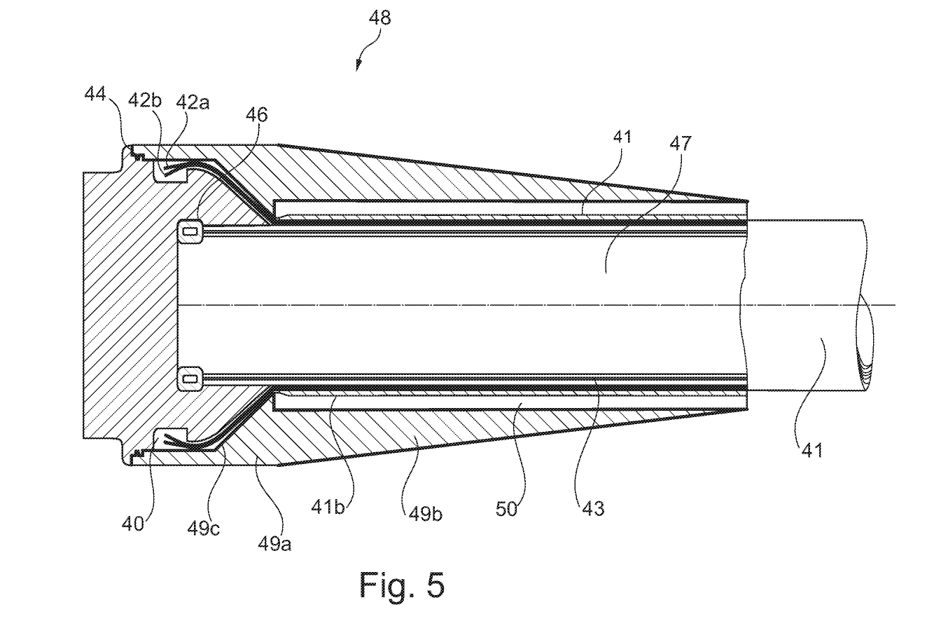

FIG. 5 shows an assembly of a flexible pipe 47 and an end-fitting 48 of the invention further comprising a bearing element 50 arranged between the outer sheath 41 of the flexible pipe 47 and the integrated stiffener body 49b.

The assembly comprises the outer casing with a thin metal film 49c and a strain-bearing fiber armored polymer layer 39a integrated with stiffener 49b for stiffening the pipe 47. The unbonded flexible pipe 47 comprises an outer sealing sheath 41, surrounding two cross wound tensile armor layers 42a, 42b. Inside the cross wound tensile armor layers 42a, 42b, the pipe comprises a number of other layers 43, including at least a liquid impervious inner sealing sheath and preferably additional layers as described above. The layers 43 inside the cross wound tensile armor layers 42a, 42b will usually be terminated individually, as schematically shown in the drawing with the terminating unit 46.

The end-fitting 48 comprises an end-fitting body 44 with a not shown mounting flange. The end-fitting 48 further comprises the annular outer casing 49a, 49c. The annular outer casing 49a, 49c is integrated with the stiffener 49b in that the fiber armored polymer layer 49a of the annular outer casing and the stiffener 49b are in direct prolongation of each other—i.e. built together. A housing cavity 40 is formed between the end-fitting body 44 and the outer casing 49a. The outer sealing sheath 41 is terminated at a termination point 41a in well known manner. The tensile armor elements of the tensile armor layers 42a, 42b are terminated and secured by securing material in the housing cavity 40 of said end-fitting 48. The bearing element 50 can be as described above and advantageously the bearing element 50 is arranged such that it can be replaced upon wear.

The figures are schematic and may be simplified for clarity. Throughout, the same reference numerals are used for identical or corresponding parts.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Some preferred embodiments have been shown in the foregoing, but it should be stressed that the invention is not limited to these, but may be embodied in other ways within the subject-matter defined in the following claims.

What is claimed is:

1-39. (canceled)

40. An assembly of a flexible pipe and an end-fitting, wherein the flexible pipe comprises a plurality of layers including an outermost armor layer, at least said outermost armor layer being terminated and secured by securing material in a housing cavity of said end-fitting, wherein the end-fitting comprises an annular end-fitting body structure and an annular outer casing, wherein an upper wall section of the housing cavity is provided by said outer casing, the outer casing comprises a strain-bearing fiber armored polymer layer arranged such that a tensile load subjected to said secured outermost armor layer results in strain in said strain-bearing fiber armored polymer layer.

41. The assembly as claimed in claim 40, wherein the assembly comprises an integrated stiffener for stiffening the pipe in a stiffened pipe section adjacent to the end-fitting, wherein the stiffener comprises a stiffener body which is an integrated extension of the strain-bearing fiber armored polymer layer of the outer casing.

42. The assembly as claimed in in claim 40, wherein the outer casing consists essentially of polymer and fibers and comprises a fiber armored polymer layer.

43. The assembly as claimed in claim 40, wherein the assembly comprises an integrated stiffener for stiffening the pipe in a stiffened pipe section adjacent to the end-fitting, wherein the integrated stiffener body has a length determined from the annular end-fitting body structure and along the length of the pipe, the length of the integrated stiffener body is at least about ½ m.

44. The assembly as claimed in claim 40, wherein the assembly comprises an integrated stiffener for stiffening the pipe in a stiffened pipe section adjacent to the end-fitting, wherein the concentration of fibers in % by volume varies along the length of the integrated stiffener body.

45. The assembly as claimed in claim 40, wherein the assembly comprises an integrated stiffener for stiffening the pipe in a stiffened pipe section adjacent to the end-fitting, wherein the type, types and/or structure of fibers in the integrated stiffener body varies along the length of the integrated stiffener body.

46. The assembly as claimed in claim 40, wherein the assembly comprises an integrated stiffener for stiffening the pipe in a stiffened pipe section adjacent to the end-fitting, wherein the integrated stiffener body is a tubular stiffener body with a wall thickness, wherein the wall thickness varies along the length of the integrated stiffener body.

47. The assembly as claimed in claim 40, wherein the assembly comprises an integrated stiffener for stiffening the pipe in a stiffened pipe section adjacent to the end-fitting, wherein the integrated stiffener body is a tubular stiffener body with a wall thickness, wherein the wall thickness is substantially identical along at least about 90 of the length of the integrated stiffener body.

48. The assembly as claimed in claim 40, wherein the assembly comprises an integrated stiffener for stiffening the pipe in a stiffened pipe section adjacent to the end-fitting, wherein the integrated stiffener body is a layered structure.

49. The assembly as claimed in claim 40, wherein the fibers of the strain-bearing fiber armored polymer layer of the outer casing are predominantly oriented with length directions in the length direction of the assembly of the unbonded flexible pipe and the end-fitting.

50. The assembly as claimed in claim 40, wherein the polymer of the strain-bearing fiber armored polymer layer is or comprises a thermoset polymer, selected from epoxy resins, vinyl-epoxy-ester resins, polyester resins, polyimide resins, bis-maleimide resins, cyanate ester resins, vinyl resins, benzoxazine resins, benzocyclobutene resins, or mixtures comprising at least one of the forgoing thermoset polymers.

51. The assembly as claimed in claim 40, wherein the polymer of the strain-bearing fiber armored polymer layer is or comprises a thermoplastic polymer, such as polyolefin, polyamide, polyimide, polyamide-imide, polyester, polyurethane, polyacrylate or mixtures comprising at least one of the forgoing thermoplastic polymers.

52. The assembly as claimed in claim 40, wherein the assembly comprises an integrated stiffener for stiffening the pipe in a stiffened pipe section adjacent to the end-fitting, wherein the fibers of the strain-bearing fiber armored polymer layer of the outer casing are predominantly oriented with length directions in the length direction of the assembly and the fibers of the stiffener body are predominantly oriented with length directions perpendicular to the length direction of the assembly.

53. The assembly as claimed in claim 40, wherein the assembly comprises an integrated stiffener for stiffening the pipe in a stiffened pipe section adjacent to the end-fitting, wherein the major amount of the fibers of the integrated stiffener body is in the form of continuous fibers, preferably at least about 60% by weight of the fibers are in the form of continuous fibers, such as continuous filaments, continuous yarns, continuous rovings or combinations thereof.

54. The assembly as claimed in claim 40, wherein the assembly comprises an integrated stiffener for stiffening the pipe in a stiffened pipe section adjacent to the end-fitting, wherein the polymer of the integrated stiffener body is or comprises a thermoset polymer, selected from epoxy resins, vinyl-epoxy-ester resins, polyester resins, polyimide resins, bis-maleimide resins, cyanate ester resins, vinyl resins, benzoxazine resins, benzocyclobutene resins, or mixtures comprising at least one of the forgoing thermoset polymers.

55. The assembly as claimed in claim 40, wherein the assembly comprises an integrated stiffener for stiffening the pipe in a stiffened pipe section adjacent to the end-fitting, wherein the polymer of the integrated stiffener body is or comprises a thermoplastic polymer, such as polyolefin, polyamide, polyimide, polyamide-imide, polyester, polyurethane, polyacrylate or mixtures comprising at least one of the forgoing thermoplastic polymers.

56. The assembly as claimed in claim 40, wherein the assembly comprises an integrated stiffener for stiffening the pipe in a stiffened pipe section adjacent to the end-fitting, wherein the integrated stiffener body has an inner side adapted to face towards the pipe, the inner side of the integrated stiffener body comprises channels, preferably oriented in length direction or in a helically configuration.

57. The assembly as claimed in claim 40, wherein the assembly comprises an integrated stiffener for stiffening the pipe in a stiffened pipe section adjacent to the end-fitting, wherein the integrated stiffener body comprises voids which are open to allow water to enter the voids when submerged under water.

58. The assembly as claimed in claim 40, wherein the assembly comprises an integrated stiffener for stiffening the pipe in a stiffened pipe section adjacent to the end-fitting, wherein the assembly comprises a bearing element arranged between the flexible pipe and the integrated stiffener body, the bearing element.

59. The assembly as claimed in claim 58, wherein the bearing element is applied to surround an outer surface of the flexible pipe, the bearing element has an outer surface facing the inner side of the integrated stiffener body, the outer surface of the bearing element has a lower friction than the outer surface of the flexible pipe.
